(19) United States
(12) Patent Application Publication
(10) Pub. No.: US 2019/0123603 A1
(43) Pub. Date: Apr. 25, 2019

(54) ROTOR OF ROTATING ELECTRICAL MACHINE

(71) Applicant: DENSO CORPORATION, Kariya-city, Aichi-pref (JP)

(72) Inventors: Yuki TAKAHASHI, Kariya-city (JP); Atsuo ISHIZUKA, Kariya-city (JP)

(73) Assignee: DENSO CORPORATION, Kariya-city, Aichi-pref. (JP)

(21) Appl. No.: 16/306,692

(22) PCT Filed: Jun. 1, 2017
(86) PCT No.: PCT/JP2017/020446

§ 371 Date: Dec. 3, 2018

(30) Foreign Application Priority Data
Jun. 3, 2016 (JP) 2016-112287

(51) Int. Cl. H02K 1/24; H02K 19/22; H02K 21/04; H02K 1/27

(52) U.S. Cl. CPC H02K 1/243; H02K 1/27; H02K 21/044; H02K 19/22

(57) ABSTRACT

A rotor of a rotating electrical machine includes a field core having a boss portion, multiple disc portions, and multiple claw-shaped magnetic pole portions; a field winding wound around an outer peripheral side of the boss portion to generate magnetomotive force by power application; and a tubular member arranged so as to cover the outer periphery of the claw-shaped magnetic pole portions. The tubular member includes multiple steel plates stacked in an axial direction, and is configured such that an inner diameter in a steady state is smaller than the outer diameter of the claw-shaped magnetic pole portions.

### CROSS-REFERENCE TO RELATED APPLICATION

The present application is based on and claims the benefit of priority from Japanese Patent Application No. 2016-112287, filed on Jun. 3, 2016, the entire description of which is incorporated herein by reference.

### TECHNICAL FIELD

The present disclosure relates to a rotor of a rotating electrical machine that is installed in, for example, an automobile or a truck, and is used as an electrical motor or an electrical generator.

### BACKGROUND ART

A rotating electrical machine including a stator, around which a stator winding is wound, and a rotor rotatably arranged in a state of facing the stator with an electromagnetic gap in a radial direction is known as a typical rotating electrical machine. A Lundell rotor including a field core having multiple claw-shaped magnetic pole portions and a field winding is known as a rotor of the rotating electrical machine. At the field core, a cylindrical boss portion fixed to a rotary shaft and magnetic poles arranged on an outer peripheral side of the boss portion and alternately having different polarities in a circumferential direction are formed. The field winding is wound around the outer peripheral side of the boss portion to generate magnetomotive force by power application.

Patent Literature 1 discloses a tubular magnetic pole tube portion (a tubular member) including a stack of multiple soft magnetic plates in an axial direction and arranged on an outer peripheral side of claw-shaped magnetic pole portions of a field core. This tubular member has, at an outer-radius-side surface, a convex portion corresponding to the contour shape of the claw-shaped magnetic pole portion, and a concave portion corresponding to an air gap between adjacent ones of the claw-shaped magnetic pole portions. The convex and concave portions of the tubular member are connected in a slope shape. Thus, according to the tubular member of Patent Literature 1, when a rotor rotates, fluctuation in a magnetic flux acting on a stator is mitigated so that magnetic noise can be reduced.

Moreover, Patent Literature 2 describes such a technique in which a band plate-shaped soft magnetic elongated plate having a round hole or a slit is spirally wound into a stack in an axial direction to form a rotor core.

### CITATION LIST

### Patent Literature

[PTL 1] JP 2009-148057 A
[PTL 2] JP 2001-359263 A

### SUMMARY OF THE INVENTION

At a member arranged on an outer peripheral side of claw-shaped magnetic pole portions of a field core, such as the tubular member described in Patent Literature 1, there are portions where floating (a clearance) from an outer peripheral surface of the claw-shaped magnetic pole portion is present and portions where no floating is present, in the case of insufficient roundness. For this reason, there are a strong portion and a non-strong portion in terms of vibration-resistance strength. Specifically, in many cases, chattering noise of the claw-shaped magnetic pole portions due to vibration is taken as a factor for lowering of performance of a Lundell motor. In the case of Patent Literature 1, such a situation easily often occurs. In this situation, at the portion where floating is present, magnetic resistance by the air gap is increased, and lowering of magnetic force also occurs accordingly.

Moreover, in the technique described in Patent Literature 2, the band plate-shaped soft magnetic elongated plate having the round hole or the slit is spirally wound to produce the cylindrical rotor core. In this case, the stress concentration factor is increased at a distorted (plastically-deformed) portion, and therefore, this is obviously unfavorable in strength design. Moreover, a clearance is formed at the distorted portion, and for this reason, a capacity as a component of a magnetic circuit is lowered. As a result, it is obvious that a magnetic body will become roughened and magnetic performance will be lowered.

The present disclosure is, as a problem to be solved, intended to provide a rotating electrical machine rotor configured so that improvement of torque due to reduction of magnetic resistance and avoidance of lowering of strength due to vibration of claw-shaped magnetic pole portions can be realized by elimination of a clearance between a tubular member arranged on an outer peripheral side of the claw-shaped magnetic pole portions and each claw-shaped magnetic pole portion.

In a first aspect of the present disclosure, a rotor of a rotating electrical machine includes a field core including a tubular boss portion, multiple disc portions protruding outward in a radial direction from an end portion of the boss portion in an axial direction at a predetermined pitch in a circumferential direction, and multiple claw-shaped magnetic pole portions each protruding in the axial direction from outer peripheral end portions of the disc portions to an outer peripheral side of the boss portion and alternately magnetized to different polarities in the circumferential direction, a field winding wound around the outer peripheral side of the boss portion to generate magnetomotive force by power application, and a tubular member arranged to cover the outer periphery of the claw-shaped magnetic pole portions; and the tubular member includes multiple steel plates stacked in the axial direction, and is configured such that an inner diameter in a steady state is smaller than the outer diameter of the claw-shaped magnetic pole portions.

According to this configuration, the tubular member includes the multiple steel plates stacked in the axial direction, and is configured such that the inner diameter in the steady state is smaller than the outer diameter of the claw-shaped magnetic pole portions.

Thus, when the tubular member is attached to the outer periphery of the claw-shaped magnetic pole portions, an inner peripheral surface of the tubular member is pressed in close contact with outer peripheral surfaces of the claw-shaped magnetic pole portions, and therefore, no clearance (no air gap) is formed between each claw-shaped magnetic pole portion and the tubular member.
With this configuration, improvement of torque due to reduction of electric resistance and avoidance of lowering of strength due to vibration of the claw-shaped magnetic pole portions can be realized.

### BRIEF DESCRIPTION OF THE DRAWINGS

FIG. 1 is an axial sectional view of a rotating electrical machine equipped with a rotor according to a first embodiment.

FIG. 2 is a perspective view of the rotor according to the first embodiment.

FIG. 3 is a perspective view of the rotor according to the first embodiment with a tubular member being detached.

FIG. 4 is a front view of the rotor according to the first embodiment viewed from an axial direction with the tubular member being detached.

FIG. 5 is a perspective view of a steady state of the tubular member according to the first embodiment.

FIG. 6 is a perspective view of a state where the tubular member according to the first embodiment is attached to the outer periphery of claw-shaped magnetic pole portions.

FIG. 7 is a view illustrating a dimension relationship between a field core and the tubular member in the first embodiment.

FIG. 8 is a view illustrating a dimension relationship between a field core and a tubular member in a first modification.

FIG. 9 is a view illustrating the state of the tubular member attached to the outer periphery of the claw-shaped magnetic pole portions and the state of the claw-shaped magnetic pole portions in the first embodiment.

FIG. 10 is a view illustrating the state of the deformed claw-shaped magnetic pole portion when centrifugal force acts in the rotor according to the first embodiment.

FIG. 11 is a characteristic diagram illustrating a relationship between a tempering temperature after quenching has been performed for steel with a carbon amount of 0.4% and a yield point.

FIG. 12 is a characteristic diagram illustrating a relationship between the tempering temperature after quenching and breaking stress when a rod material is taken as a beam and breaking force is applied perpendicularly to a longitudinal direction of the beam.

FIG. 13 is a perspective view of a rotor according to a second embodiment.

FIG. 14 is a perspective view of a steady state of a tubular member according to the second embodiment.

FIG. 15 is a perspective view of a state where the tubular member according to the second embodiment is attached to the outer periphery of claw-shaped magnetic pole portions.

FIG. 16 is a view illustrating the state where the tubular member is bonded to the outer periphery of the claw-shaped magnetic pole portions in the second embodiment.

FIG. 17 is a view illustrating a state where a tubular member is bonded to the outer periphery of claw-shaped magnetic pole portions in a second modification.

FIG. 18 is a perspective view of a rotor according to a third modification.

### DESCRIPTION OF EMBODIMENTS

Hereinafter, embodiments of a rotor of a rotating electrical machine according to the present invention will be specifically described with reference to the drawings.

### First Embodiment

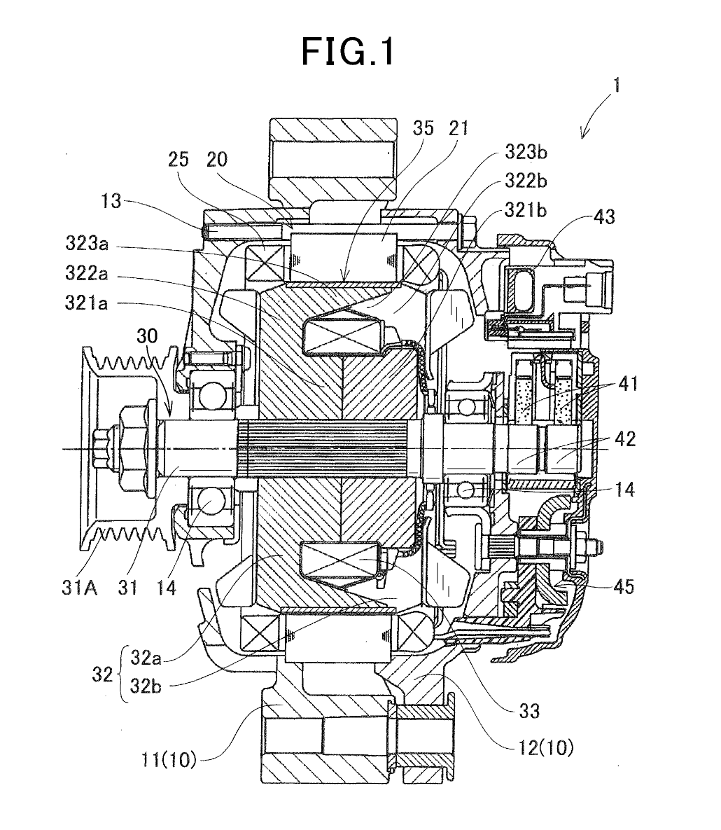

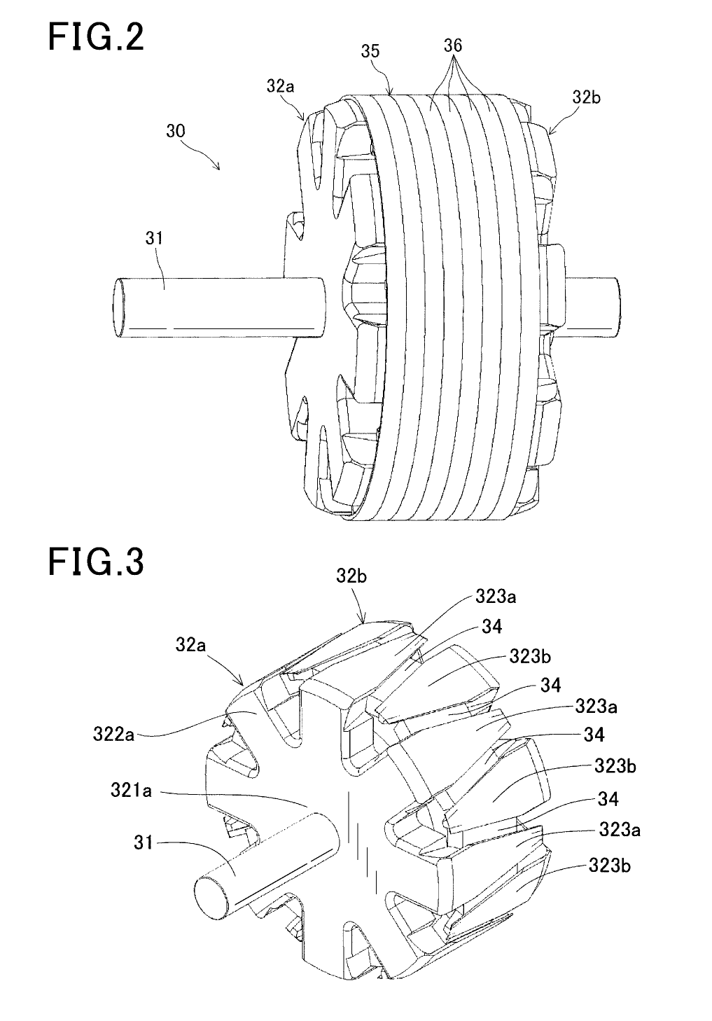

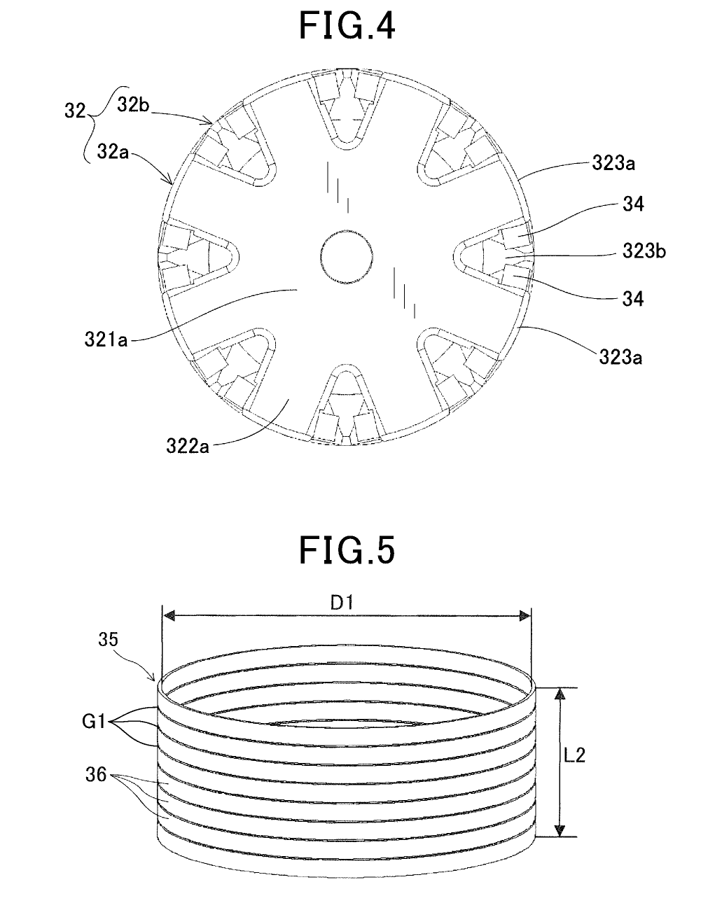

A rotor of a rotating electrical machine according to a first embodiment will be described with reference to FIGS. 1 to 12. The rotor of the first embodiment is, for example, installed in the rotating electrical machine used as a vehicle AC generator 1, and as illustrated in FIGS. 1 and 2, includes a housing 10, a stator 20, a rotor 30, a field winding power feeding mechanism, a rectifier 45, and the like.

The housing 10 includes a front housing 11 and a rear housing 12, each of the front housing 11 and the rear housing 12 being in a bottomed cylindrical shape opening at one end. The front housing 11 and the rear housing 12 are fastened with a bolt 13 with the openings being joined to each other. The stator 20 has a circular ring-shaped stator core 21 having not-shown multiple slots and teeth arranged in a circumferential direction, and an armature winding 25 having three phase windings wound around the slots of the stator core 21. The stator 20 is fixed to inner peripheral wall surfaces of the front housing 11 and the rear housing 12 with the stator 20 being sandwiched by the inner peripheral wall surfaces in an axial direction.

The rotor 30 is arranged inside the stator 20 in a radial direction, and is provided rotatably together with a rotary shaft 31, the rotary shaft 31 being rotatably supported on the housing 10 through a pair of bearings 14. The rotor 30 is a Lundell rotor having a field core 32 with a pair of pole cores 32a, 32b, and a field winding 33. The rotor 30 is, through a pulley 31A fixed to a front end portion of the rotary shaft 31, rotatably driven by a not-shown engine installed in a vehicle. The field winding power feeding mechanism is a device configured to feed electrical power to the field winding 33, and has a pair of brushes 41, a pair of slip rings 42, a regulator 43, and the like.

When rotation force is transmitted from the engine to the pulley 31A through a not-shown belt and the like, the rotor 30 rotates in a predetermined direction together with the rotary shaft 31 in the vehicle AC generator 1 having the above-described configuration. In this state, first and second claw-shaped magnetic pole portions 323a, 323b of the first and second pole cores 32a, 32b are excited in such a manner that excitation voltage is applied to the field winding 33 of the rotor 30 from the brushes 41 through the slip rings 42. As a result, NS magnetic poles are alternately formed along a rotation circumferential direction of the rotor 30. Accordingly, a rotating magnetic field is provided to the armature winding 25 of the stator 20, and therefore, AC electromotive force is generated at the armature winding 25. The AC electromotive force generated at the armature winding 25 is supplied to a not-shown battery after having been rectified into DC current through the rectifier 45.

Next, a characteristic configuration of the rotor 30 of the first embodiment will be described in detail with reference to FIGS. 1 to 10. As illustrated in FIGS. 1 to 4 and 10, the rotor 30 of the first embodiment has the rotary shaft 31 rotatably supported on the housing 10 through the pair of bearings 14, 14, the field core 32 configured by the pair of pole cores 32a, 32b fitted and fixed onto the outer periphery of the rotary shaft 31, the field winding 33 wound around a boss portion 321 (321a, 321b) of the field core 32, multiple permanent magnets 34 each arranged between claw-shaped magnetic pole portions 323 (323a, 323b) adjacent in the circumferential direction of the field core 32, and a tubular member 35 arranged to cover the outer periphery of the claw-shaped magnetic pole portions 323 of the field core 32. The rotor 30 is rotatably provided in a state where of facing an inner peripheral side of the stator 20 in the radial direction.

As illustrated in FIGS. 1 and 3, the field core 32 includes the first pole core 32a fixed to a front side (the left side of FIG. 1) of the rotary shaft 31, and the second pole core 32b fixed to a back side (the right side of FIG. 1) of the rotary shaft 31. The first pole core 32a includes a cylindrical first boss portion 321a, first disc portions 322a, and the first claw-shaped magnetic pole portions 323a. The first boss portion 321a is configured to feed a field magnetic flux in the axial direction, radially inside the field winding 33. The first disc portions 322a protrude outward in the radial direction from a front end portion of the first boss portion 321a in the axial direction at predetermined pitches in the circumferential direction, thereby feeding a field magnetic flux in the radial direction. Each first claw-shaped magnetic pole portion 323a protrudes in the axial direction from an outer peripheral end portion of the first disc portion 322a to an outer peripheral side of the first boss portion 321a so as to surround the field winding 33, thereby exchanging a magnetic flux with the stator core 21.

The second pole core 32b has the same shape as that of the first pole core 32a, and includes a second boss portion 321b, a second disc portions 322b, and the second claw-shaped magnetic pole portions 323b. The first and second pole cores 32a, 32b are formed from soft magnetic bodies.

The first pole core 32a and the second pole core 32b are, in a state in which a back end surface of the first pole core 32a in the axial direction and a front end surface of the second pole core 32b in the axial direction contact each other, assembled such that the first claw-shaped magnetic pole portions 323a and the second claw-shaped magnetic pole portions 323b face each other in a staggered manner. In this manner, the first claw-shaped magnetic pole portions 323a of the first pole core 32a and the second claw-shaped magnetic pole portions 323b of the second pole core 32b are alternately arranged in the circumferential direction. The first and second pole cores 32a, 32b each have eight claw-shaped magnetic pole portions 323, and in the first embodiment, form a 16-pole (N-pole: eight, S-pole: eight) Lundell rotor core.

The field winding 33 is wound around outer peripheral surfaces of the first and second boss portions 321a, 321b with the field winding 33 being electrically insulated from the field core 32, and is surrounded by the first and second claw-shaped magnetic pole portions 323a, 323b. The field winding 33 is configured to generate magnetomotive force at a boss portion 321 by application of field current If from a not-shown field current control circuit. Accordingly, magnetic poles with different polarities are formed at the first claw-shaped magnetic pole portions 323a and the second claw-shaped magnetic pole portions 323b of the first and second pole cores 32a, 32b. In the case of the first embodiment, the first claw-shaped magnetic pole portion 323a is magnetized as an S-pole, and the second claw-shaped magnetic pole portion 323b is magnetized to as an N-pole.

In this case, a magnetic flux generated at the boss portion 321 of the field core 32 by the field winding 33 forms, for example, a magnetic circuit in which the magnetic flux flows, after having flowed from the first boss portion 321a of the first pole core 32a to the first disc portions 322a and the first claw-shaped magnetic pole portions 323a, through the second claw-shaped magnetic pole portions 323b of the second pole core 32b from the first claw-shaped magnetic pole portions 323a by way of the stator core 21, and returns to the first boss portion 321a from the second claw-shaped magnetic pole portions 323b by way of the second disc portions 322b and the second boss portion 321b. This magnetic circuit is configured to generate back electromotive force of the rotor 30.

As illustrated in FIG. 3, a clearance extending in a direction oblique to the axial direction is formed between adjacent ones of the first claw-shaped magnetic pole portions 323a and the second claw-shaped magnetic pole portions 323b alternately arranged in the circumferential direction, and the single permanent magnet 34 is arranged in each clearance. Each permanent magnet 34 has a rectangular parallelepiped outer shape, and the axis of easy magnetization thereof is directed in the circumferential direction. Moreover, each permanent magnet 34 is held by the first and second claw-shaped magnetic pole portions 323a, 323b in a state in which both end surfaces (magnetic flux inflow/outflow surfaces) of the permanent magnet 34 in the circumferential direction each contact side surfaces of the first and second claw-shaped magnetic pole portions 323a, 323b in the circumferential direction. Thus, each permanent magnet 34 is arranged such that the polarity thereof is coincident with the polarities of the first and second claw-shaped magnetic pole portions 323a, 323b alternatively provided by excitation of the field winding 33.

As illustrated in FIGS. 2 and 4 to 7, the tubular member 35 is formed in a cylindrical shape from multiple ring-shaped steel plates (soft magnetic bodies) 36 stacked in the axial direction, covers and contacts outer peripheral surfaces of the claw-shaped magnetic pole portions 323 of the field core 32, and is arranged coaxially with the field core 32. The tubular member 35 is configured such that the width thereof in the axial direction is substantially the same as the length of the claw-shaped magnetic pole portion 323 in the axial direction. Thus, the tubular member 35 is formed with such a size that the tubular member 35 covers the entire area of the outer peripheral surfaces of the claw-shaped magnetic pole portions 323.

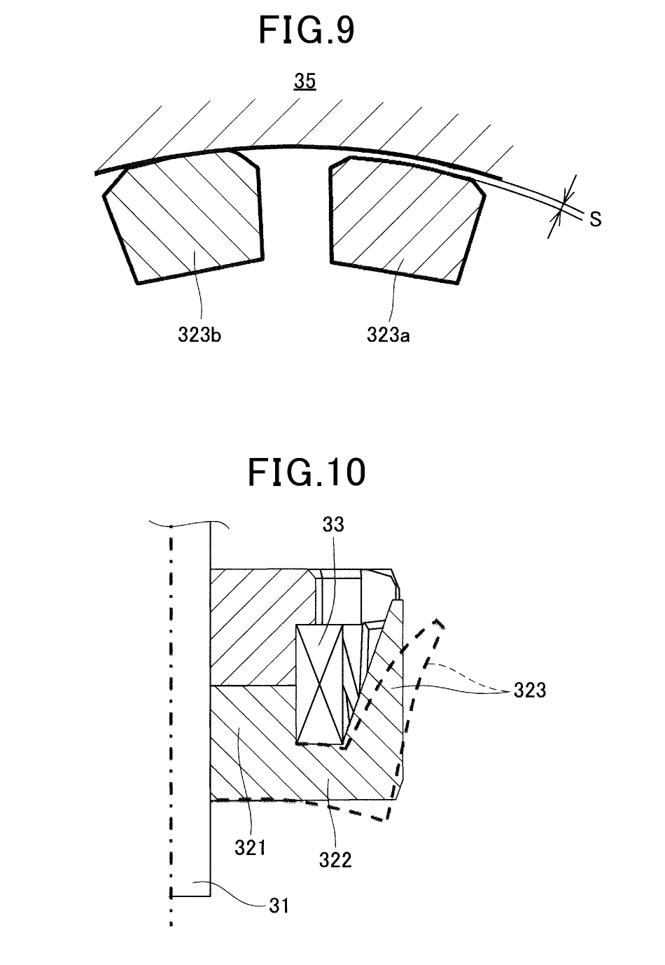

As illustrated in FIG. 7, the tubular member 35 is configured such that an inner diameter D1 in a steady state is smaller than the outer diameter D2 of the claw-shaped magnetic pole portions 323. Note that the steady state in the first embodiment means a state in which no external force is applied before the tubular member 35 is attached to the outer periphery of the field core 32. The tubular member 35 is fitted onto the outer peripheral surfaces of the claw-shaped magnetic pole portions 323 by press fitting, and is fixed in a state in which predetermined pressure acts on the outer peripheral surfaces of the claw-shaped magnetic pole portions 323. Thus, even when the first claw-shaped magnetic pole portion 323a is displaced to an inner radius side due to a manufacturing tolerance to form a clearance S as illustrated in FIG. 9, mechanical and electrical coupling among the tubular member 35 and the first claw-shaped magnetic pole portions 323a is made, and promotion of magnetic coupling and reduction of vibration force are realized.

Note that in the Lundell rotor as in the first embodiment, the claw-shaped magnetic pole portion 323 is deformed due to centrifugal force generated when the rotor 30 rotates, as illustrated in FIG. 10. Moreover, since the claw-shaped magnetic pole portion 323 extends from the base thereof, chattering vibration in a similar mode is also generated due to vibration, and the total force of centrifugal force and vibration increases stress of the claw-shaped magnetic pole portion 323. In the case of the first embodiment, an inner radius surface of the tubular member 35 presses the claw-shaped magnetic pole portion 323 as in a spring, and therefore, a vibration damper effect is obtained.

When dent portions 35A raised toward the inner radius side are formed at the tubular member 35 as in a first variation illustrated in FIG. 8, the pressing force of the dent portions 35A acts, as in a spring, on the outer peripheral surfaces of the claw-shaped magnetic pole portions 323, and therefore, a more favorable damper effect is obtained.

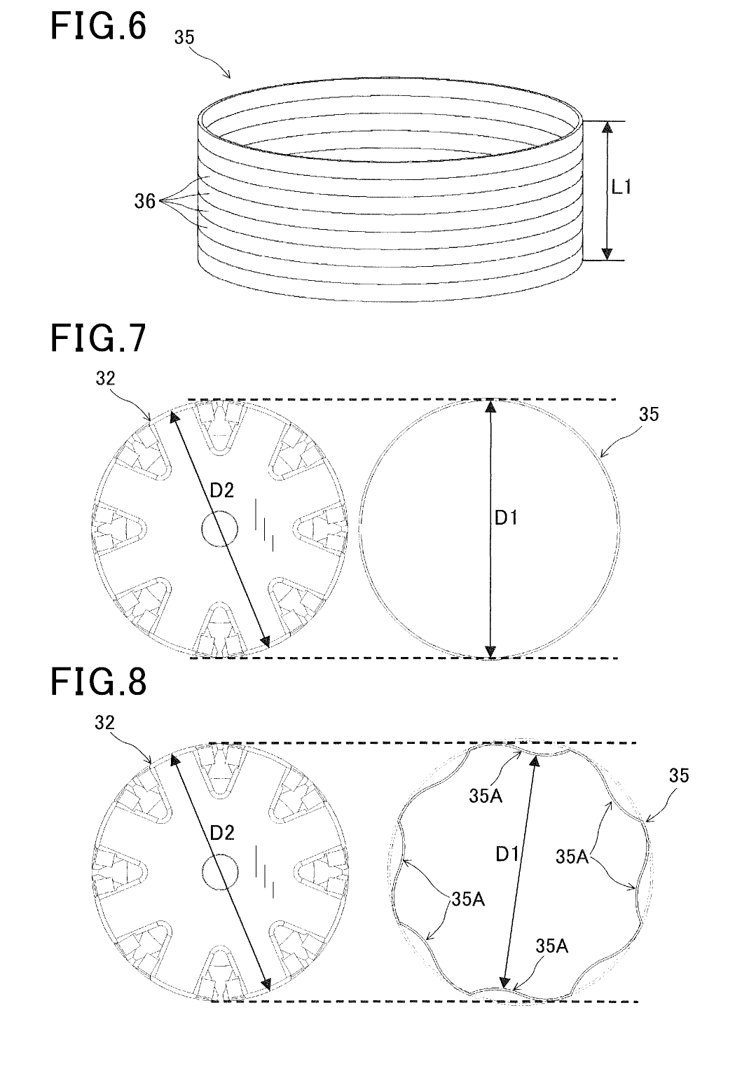

As illustrated in FIGS. 5 and 6, the tubular member 35 of the first embodiment is configured such that an axial length L1 when the tubular member 35 is attached to the outer periphery of the claw-shaped magnetic pole portions 323 is smaller than an axial length L2 in the steady state. That is, when the tubular member 35 is attached to the outer periphery of the claw-shaped magnetic pole portions 323, the steel plates 36 adjacent to each other in the axial direction are preferably closely contact each other to provide a magnetically-dense structure. Moreover, the tubular member 35 has, for reducing vibration of the tubular member 35 in the axial direction, a clearance G1 between at least a pair of the steel plates 36 adjacent in the axial direction.

The steel plate 36 forming the tubular member 35 includes a ring-shaped magnetic body and an electrical insulating layer covering both of front and back surfaces of the magnetic body. Thus, the tubular member 35 formed of the stack of the multiple steel plates 36 has a structure in which the magnetic bodies and the electrical insulating layers are alternately stacked in the axial direction. With this configuration, an eddy-current loss at the tubular member 35 can be reduced.

The magnetic body is made of a magnetic material with a carbon amount of 0.4 to 1.05%. Concisely, iron containing carbon forms a martensite structure through a tempering step after hardening by quenching or processing, and therefore, exhibits high strength. This is a well-known technique. In the present disclosure, it is effective to use this structure to provide an ideal form as a structural member. That is, it can be said that in the present disclosure, electromagnetic soft iron which cannot fully form the martensite structure is not a suitable material.

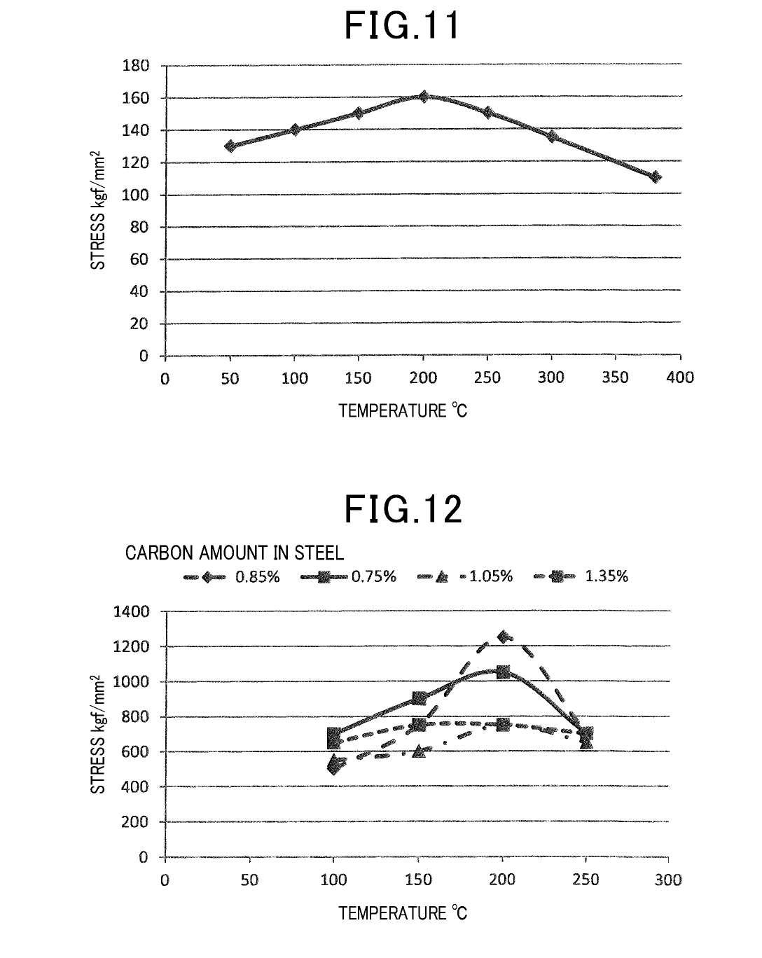

For the steel plate 36 of the first embodiment, martensite-based stainless steel or a carbon steel group exhibiting a strength level equal to or higher than that of the martensite-based stainless steel is suitable. FIG. 11 is a characteristic diagram illustrating a relationship between a tempering temperature after quenching has been performed for steel with a carbon amount of 0.4% and a yield point. FIG. 11 shows that stress increases at a temperature of 200° C. for a carbon amount of 0.4%. Thus, it can be said that an advantageous effect is confirmed when the carbon amount is 0.4%.

Moreover, FIG. 12 is a characteristic diagram illustrating a relationship between the tempering temperature after quenching and breaking stress when a rod material is used as a beam and breaking force is applied perpendicularly to a longitudinal direction of the beam. The breaking stress is applied such that stress is applied when the tubular member 35 is likely to be broken in response to force of the claw-shaped magnetic pole portion 323 or the permanent magnet 34. According to this diagram, high-carbon steel having a carbon amount different from that of S10C-class low-carbon steel typically employed as a magnetic body has the most excellent breaking stress value at about 200° C.

Considering the breaking force, a temperature range of about 80 to 200° C. in the vicinity of an installation location of the rotating electrical machine according to the first embodiment is suitable as the tempering temperature in the case of a carbon amount range of equal to or lower than 1.35%. Moreover, in the case of a carbon amount range of equal to or lower than 1.05%, a temperature range of about 80 to 200° C. in the vicinity of the installation location of the rotating electrical machine according to the first embodiment is further suitable as the tempering temperature. Thus, a member having within the above-described carbon amount is partially heated due to heat generation caused by, e.g., the centrifugal force or an iron loss of a high-energy body such as a magnet or a rotor magnetic pole portion surface and is tempered during operation, and therefore, is grown in an ideal state.

According to description above, it can be said that an iron-based material containing a carbon amount of 0.4% to 1.35% is suitable for the steel plate 36 of the tubular member 35 and an iron-based material containing a carbon amount of 0.4% to 1.05% is further suitable for the steel plate 36 of the tubular member 35. Moreover, materials classified according to JIS symbols as SK, SUP, SWRH, SWRS, and the like each called carbon tool steel, hard steel wire rods, piano wire rods, and martensite-based stainless steel are preferably suitable for the steel plate 36 of the tubular member 35.

According to the rotor 30 of the first embodiment configured as described above, the tubular member 35 includes the multiple steel plates 36 stacked in the axial direction, and the inner diameter D1 in the steady state is smaller than the outer diameter D2 of the claw-shaped magnetic pole portions 323. Thus, when the tubular member 35 is attached to the outer periphery of the claw-shaped magnetic pole portions 323, an inner peripheral surface of the tubular member 35 is pressed in close contact with the outer peripheral surfaces of the claw-shaped magnetic pole portions 323, and therefore, no clearance (no air gap) is formed between each claw-shaped magnetic pole portion 323 and the tubular member 35. With this configuration, improvement of torque due to reduction of electric resistance and avoidance of lowering of strength due to vibration of the claw-shaped magnetic pole portions 323 can be realized.

Moreover, in the first embodiment, the tubular member 35 is configured such that the axial length L1 when the tubular member 35 is attached to the outer periphery of the claw-shaped magnetic pole portions 323 is smaller than the axial length L2 in the steady state, and has the clearance G1 between at least a pair of the steel plates 36 adjacent in the axial direction. According to this configuration, the tubular member 35 can have the magnetically-dense structure when the tubular member 35 is attached, and vibration of the tubular member 35 in the axial direction can be reduced.

Further, in the first embodiment, the steel plate 36 forming the tubular member 35 is made of the magnetic material having a carbon amount of 0.4 to 1.05%. Thus, in the rotating electrical machine used under environment where a temperature change is great between a vehicle operation state and an operation stop state, material degradation in the vehicle operation state and low-temperature tempering in the vehicle operation stop state are repeated. Thus, a material composition of the steel plate 36 is automatically restored. Consequently, product strength is ensured at a high level without thermal degradation.

### Second Embodiment

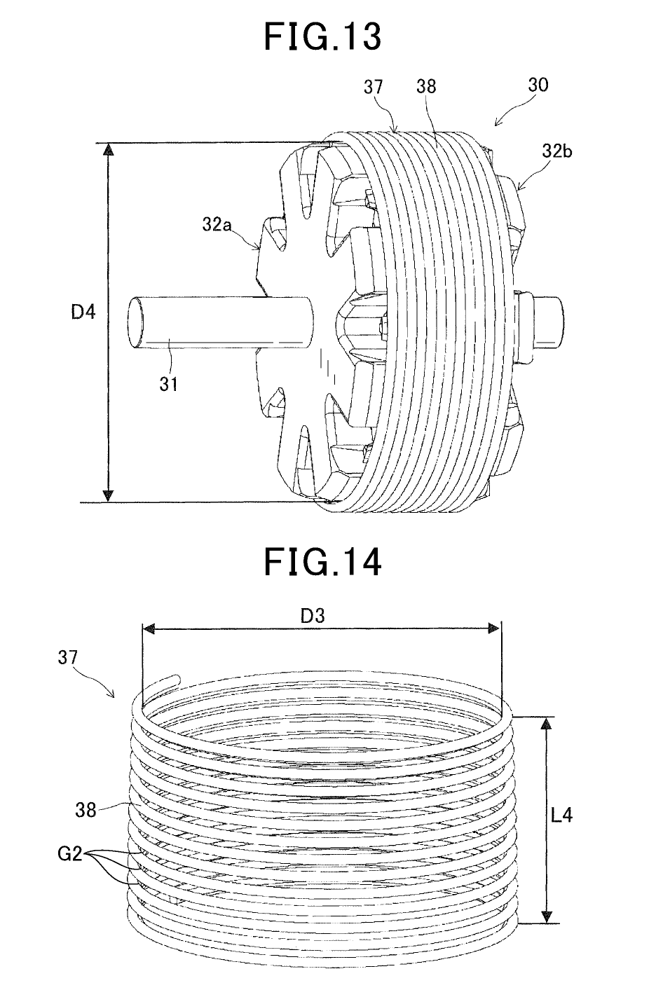

A rotor 30 according to a second embodiment will be described with reference to FIGS. 13 to 18. A basic configuration of the rotor 30 according to the second embodiment is the same as that of the first embodiment, but the rotor 30 according to the second embodiment is different from that of the first embodiment only in a configuration of a tubular member 37. Hereinafter, differences and important points will be described. Note that the same reference numerals are used to represent elements common to those of the first embodiment, and detailed description thereof will be omitted.

The tubular member 37 of the second embodiment includes a steel wire 38 spirally wound to form a stack in an axial direction. The tubular member 37 is configured such that an inner diameter D3 (FIG. 14) in a steady state is smaller than the outer diameter D4 (FIG. 13) of claw-shaped magnetic pole portions 323. Note that the steady state in the second embodiment means a state in which no external force is applied before the tubular member 37 is attached to the outer periphery of a field core 32. The tubular member 37 is fitted onto outer peripheral surfaces of the claw-shaped magnetic pole portions 323 by press fitting, and is fixed in a state in which predetermined pressure acts on the outer peripheral surfaces of the claw-shaped magnetic pole portions 323. Thus, even when the claw-shaped magnetic pole portion 323 is displaced to an inner radius side due to a manufacturing tolerance to form a clearance S, mechanical and electrical coupling among the tubular member 37 and the claw-shaped magnetic pole portions 323 is produced, and promotion of magnetic coupling and reduction of vibration force are realized (see FIG. 9).

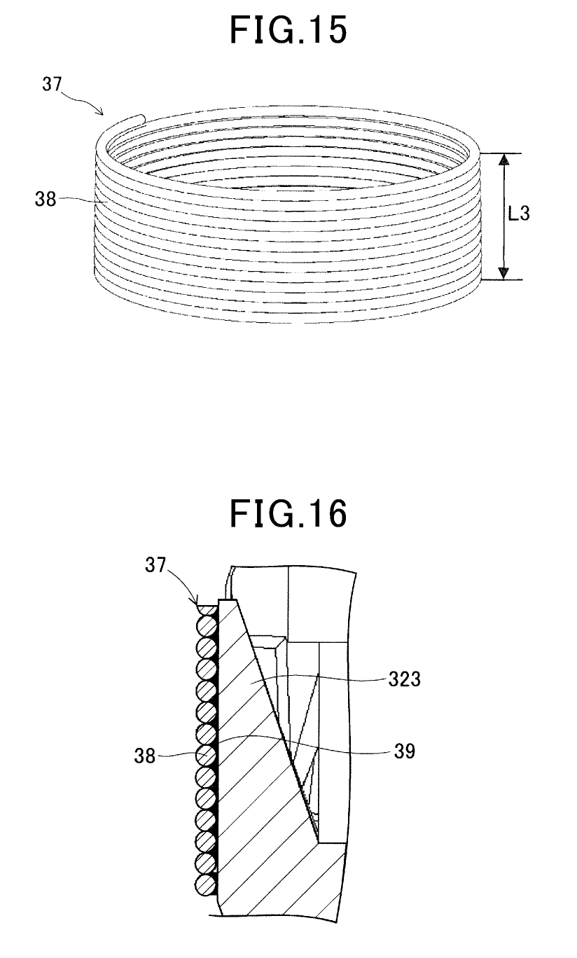

Moreover, as illustrated in FIGS. 14 and 15, the tubular member 37 is configured such that an axial length L3 when the tubular member 37 is attached to the outer periphery of the claw-shaped magnetic pole portions 323 is smaller than the natural length (the axial length of the tubular member 37 in a state in which no external force is applied before the tubular member 37 is attached to the outer periphery of the field core 32) of the tubular member 37. With this configuration, a magnetically-dense structure is provided when the tubular member 37 is attached to the outer periphery of the claw-shaped magnetic pole portions 323. Further, the tubular member 37 has, for reducing vibration of the tubular member 37 in the axial direction, a clearance G2 between at least a pair of the steel wires 38 adjacent in the axial direction of the tubular member 37.

The steel wire 38 forming the tubular member 37 includes a steel wire rod having a circular section, and an electrical insulating layer covering an outer peripheral surface of the steel wire rod. As in the first embodiment, the steel wire rod is made of a magnetic material preferably having a carbon amount of 0.4 to 1.35% and more preferably 0.4 to 1.05%. Moreover, as illustrated in FIG. 16, the tubular member 37 is configured such that adjacent turns of the steel wire 38 in the axial direction are coupled and fixed on an inner peripheral side by a resin adhesive 39 applied to between the outer peripheral surface of each claw-shaped magnetic pole portion 323 and an inner peripheral surface of the tubular member 37.

According to the rotor 30 of the second embodiment configured as described above, the tubular member 37 includes the steel wire 38 spirally wound to form the stack in the axial direction, and the inner diameter D3 in the steady state is smaller than the outer diameter D4 of the claw-shaped magnetic pole portions 323. Thus, no clearance (no air gap) is formed between each claw-shaped magnetic pole portion 323 and the tubular member 37. Consequently, according to the rotor 30 of the second embodiment, advantageous effects similar to those of the first embodiment are provided, which include, for example, improvement of torque due to reduction of electric resistance and avoidance of lowering of strength due to vibration of the claw-shaped magnetic pole portions 323.

Further, in the second embodiment, the tubular member 37 is configured such that adjacent turns of the steel wire 38 in the axial direction are coupled and fixed on the inner peripheral side by the resin adhesive 39. Thus, occurrence of a defect such as disassembly of the tubular member 37 can be prevented when the weight of the tubular member 37 itself or impact load is input or a composition is changed due to tempering.

### Other Embodiments

The present invention is not limited to the above-described embodiments, and various modifications can be made without departing from the spirit of the present invention.

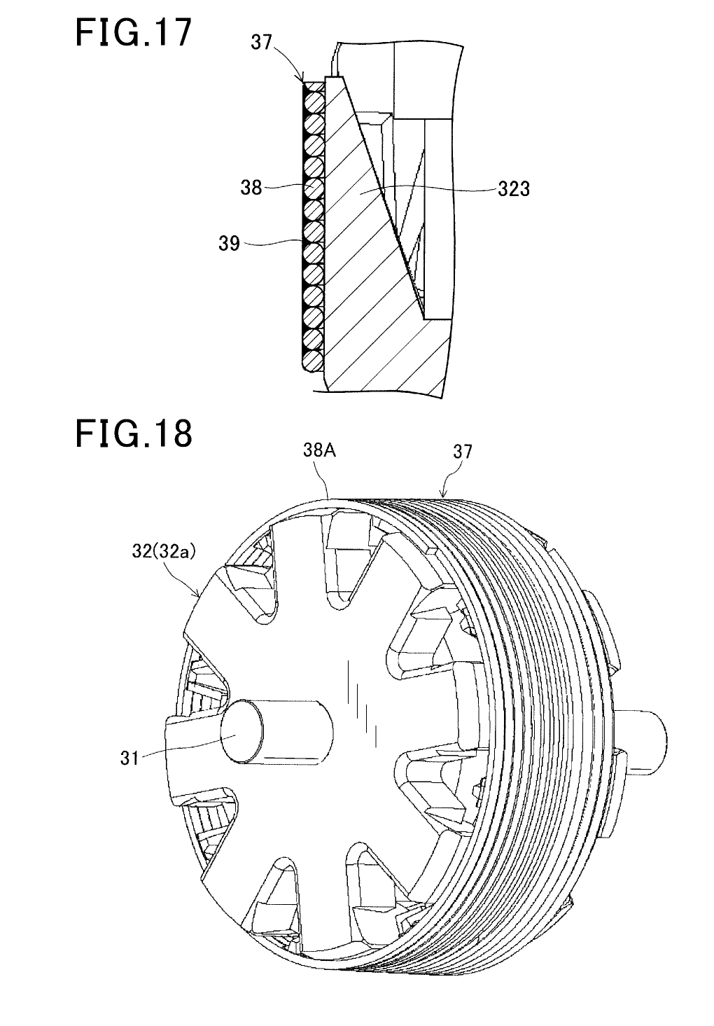

For example, in the second embodiment, the tubular member 37 is configured such that adjacent turns of the steel wire 38 in the axial direction are coupled and fixed on the inner peripheral side, but as in a second modification illustrated in FIG. 17, adjacent turns of the steel wire 38 in the axial direction may be coupled and fixed on the outer peripheral side by, e.g., the resin adhesive 39 applied onto an outer peripheral surface of the tubular member 37. Alternatively, the tubular member 35 of the first embodiment may be, as in the second embodiment, configured such that the adjacent steel plates 36 in the axial direction are coupled and fixed on the inner peripheral side or the outer peripheral side by the resin adhesive or the like.

Moreover, in the second embodiment, the steel wire 38 forming the tubular member 37 has the circular section, but instead, a steel wire 38A having a rectangular section may be employed as in a third modification illustrated in FIG. 18.

Further, in the above-described embodiments, an example in which the rotor 30 according to the present invention is applied to the vehicle AC generator 1 has been described, but the present invention is also applicable not only to an electrical motor as a rotating electrical machine installed in a vehicle but also to a rotating electrical machine which can selectively use an electrical generator and an electrical motor.

### Aspects of Present Disclosure

In a first aspect of the present disclosure,

a rotor (30) of a rotating electrical machine includes a field core (32) including a tubular boss portion (321), multiple disc portions (322) protruding outward in a radial direction from an end portion of the boss portion in an axial direction at a predetermined pitch in a circumferential direction, and multiple claw-shaped magnetic pole portions (323) each protruding in the axial direction from outer peripheral end portions of the disc portions to an outer peripheral side of the boss portion and alternately magnetized to different polarities in the circumferential direction;

a field winding (33) wound around the outer peripheral side of the boss portion to generate magnetomotive force by power application; and

a tubular member (35) arranged so as to cover an outer periphery of the claw-shaped magnetic pole portions.

The tubular member includes multiple steel plates (36) stacked in the axial direction, and is configured such that an inner diameter (D1) in a steady state is smaller than the outer diameter (D2) of the claw-shaped magnetic pole portions.

According to this configuration, the tubular member includes the multiple steel plates stacked in the axial direction, and is configured such that the inner diameter in the steady state is smaller than the outer diameter of the claw-shaped magnetic pole portions. Thus, when the tubular member is attached to the outer periphery of the claw-shaped magnetic pole portions, an inner peripheral surface of the tubular member is pressed in close contact with outer peripheral surfaces of the claw-shaped magnetic pole portions, and therefore, no clearance (no air gap) is formed between each claw-shaped magnetic pole portion and the tubular member. With this configuration, improvement of torque due to reduction of electric resistance and avoidance of lowering of strength due to vibration of the claw-shaped magnetic pole portions can be realized.

In a second aspect of the present disclosure, the tubular member is, in the first aspect, configured such that an axial length (L1) when the tubular member is attached to the outer periphery of the claw-shaped magnetic pole portions is smaller than an axial length (L2) in a steady state, and has a clearance (G1) between at least a pair of the steel plates adjacent in the axial direction. According to this configuration, the tubular member can have a magnetically-dense structure when the tubular member is attached to the tubular member. Moreover, vibration of the tubular member in the axial direction can be reduced. Note that even when the clearance between the steel plates is a minute clearance between insulating coating films provided on surfaces of the steel plates, a certain level of vibration reduction effect can be obtained. Alternatively, when the tubular member is attached to the outer periphery of the claw-shaped magnetic pole portions, the coefficient of friction of a contact surface between the tubular member and the claw-shaped magnetic pole portion may be increased without a member for fixing the tubular member being provided, and therefore, a position in the axial direction may be fixed. In this state, irregularity due to cutting marks generally formed as air gaps at the outer peripheral surfaces of the claw-shaped magnetic pole portions is more preferably utilized because the irregularity can be freely formed.

In a third aspect of the present disclosure, a rotor (30) of a rotating electrical machine includes a field core (32) including a tubular boss portion (321), multiple disc portions (322) protruding outward in a radial direction from an end portion of the boss portion in an axial direction at a predetermined pitch in a circumferential direction, and multiple claw-shaped magnetic pole portions (323) each protruding in the axial direction from outer peripheral end portions of the disc portions to an outer peripheral side of the boss portion and alternately magnetized to different polarities in the circumferential direction;

a field winding (33) wound around the outer peripheral side of the boss portion to generate magnetomotive force by power application; and

a tubular member (37) arranged to cover the outer periphery of the claw-shaped magnetic pole portions.

The tubular member includes a steel wire (38, 38A) spirally wound to form a stack in the axial direction, and is configured such that an inner diameter (D3) in a steady state is smaller than an outer diameter (D4) of the claw-shaped magnetic pole portions.

According to this configuration, the tubular member includes the steel wire spirally wound to form the stack in the axial direction, and is configured such that the inner diameter in the steady state is smaller than the outer diameter of the claw-shaped magnetic pole portions. Thus, when the tubular member is attached to the outer periphery of the claw-shaped magnetic pole portions, an inner peripheral surface of the tubular member is pressed in close contact with outer peripheral surfaces of the claw-shaped magnetic pole portions, and therefore, no clearance (no air gap) is formed between each claw-shaped magnetic pole portion and the tubular member. With this configuration, improvement of torque due to reduction of electrical resistance and avoidance of lowering of strength due to vibration of the claw-shaped magnetic pole portions can be realized. Moreover, the tubular member can be attached to the outer periphery of the claw-shaped magnetic pole portions with the diameter of the tubular member being expanded when the tubular member is attached, and therefore, the process of attaching the tubular member is facilitated.

In a fourth aspect of the present disclosure, the tubular member is, in the third aspect, configured such that an axial length (L3) when the tubular member is attached to the outer periphery of the claw-shaped magnetic pole portions is smaller than a natural length (L4) of the tubular member, and has a clearance (G2) between at least a pair of turns of the steel wire adjacent in the axial direction. According to this configuration, vibration of the tubular member in the axial direction can be reduced. Note that attachment of the tubular member to the claw-shaped magnetic pole portions is similar to that of the second aspect.

In a fifth aspect of the present disclosure, a magnetic material forming the tubular member has, in any one of the first to fourth aspects, a carbon amount of 0.4 to 1.05%. A rotating electrical machine equipped with the rotor of the present disclosure, such as a motor, is used under environment with a great temperature change from a negative value to equal to or higher than 100° C. Thus, the present disclosure is employed so that the tubular member receiving heat from a claw-shaped magnetic pole portion surface as a heat generation source, a permanent magnet as an adjacent heat generation source, or a stator within a use temperature range produces a low-temperature tempering effect to automatically restore a composition. Distortion due to centrifugal force or stress due to a temperature change is heated by the very high current at the start of idling stop or a great iron or copper loss, and for this reason, the tubular member is specifically exposed to a high temperature. Generally, it is obvious that the same applies to the low-heat-capacity thin tubular member of the present invention, the tubular member receiving heat from a heat generation source designed with limitations of 100 to 200° C. By repeating this condition and cooling in a vehicle unattended state, material degradation in a vehicle use state and low-temperature tempering in a vehicle non-use state are repeated such that the material composition is automatically restored and product strength is ensured at a high level without thermal degradation.

In a sixth aspect of the present disclosure, the tubular member is, in any one of the first to fifth aspects, configured such that the steels adjacent in the axial direction are coupled and fixed on an inner peripheral side. According to this configuration, occurrence of a defect such as disassembly of the tubular member can be prevented when the weight of the tubular member itself or impact load is input or a composition is changed due to tempering. In Patent Literatures 1 and 2 described above and failing to make such suggestion, in a case where a material selected for low-temperature tempering and having a carbon amount of equal to or greater than 0.6% is specifically used for production, there is a probability that dimensions in the axial direction are not fixed. The carbon amount of the material described in Patent Literatures 1 and 2 is assumed to be a carbon amount of equal to or less than 0.1%, considering the suggested contents of electromagnetic properties. Note that welding, an adhesive, or the like may be employed as a fixer.

In a seventh aspect of the present disclosure, the tubular member is, in any one of the first to fifth aspects, configured such that the steels adjacent in the axial direction are coupled and fixed on an outer peripheral side. According to this configuration, the tubular member is fixed at an outer peripheral surface with an adhesive or the like, and therefore, occurrence of rust can be prevented. Note that varnish, an adhesive, and the like may be employed as the fixer. Alternatively, a material having a self fusion function may be used, the material being bonded when heated.

Note that reference numerals in parentheses written after the members and parts in the specification, the claims, and the abstract indicate correspondence with a specific member or a part described in the above-described embodiments, and do not influence any configuration described in the claims.

1. A rotor of a rotating electrical machine, the rotor comprising:
a field core including a tubular boss portion, multiple disc portions protruding outward in a radial direction from an end portion of the boss portion in an axial direction at a predetermined pitch in a circumferential direction, and multiple claw-shaped magnetic pole portions each protruding in the axial direction from outer peripheral end portions of the disc portions to an outer peripheral side of the boss portion and alternately magnetized to different polarities in the circumferential direction;
a field winding wound around the outer peripheral side of the boss portion to generate magnetomotive force by power application;
a permanent magnet arranged in a clearance formed between the claw-shaped magnetic pole portions adjacent in the circumferential direction and extending in a direction oblique to the axial direction; and
a tubular member arranged so as to cover an outer periphery of the claw-shaped magnetic pole portions, wherein
the permanent magnet is held in a state in which an outer end surface in the radial direction is apart from an inner peripheral surface of the tubular member and both end surfaces in the circumferential direction each contact side surfaces of the claw-shaped magnetic pole portions in the circumferential direction, and
the tubular member includes multiple steel plates stacked in the axial direction, and is configured such that an inner diameter in a steady state is smaller than an outer diameter of the claw-shaped magnetic pole portions.

2. The rotor of the rotating electrical machine according to claim 1, wherein
the tubular member is configured such that an axial length when the tubular member is attached to the outer periphery of the claw-shaped magnetic pole portions is smaller than an axial length in the steady state, and has a clearance between at least a pair of the steel plates adjacent in the axial direction.

3. A rotor of a rotating electrical machine, the rotor comprising:
a field core including a tubular boss portion, multiple disc portions protruding outward in a radial direction from an end portion of the boss portion in an axial direction at a predetermined pitch in a circumferential direction, and multiple claw-shaped magnetic pole portions each protruding in the axial direction from outer peripheral end portions of the disc portions to an outer peripheral side of the boss portion and alternately magnetized to different polarities in the circumferential direction;
a field winding wound around the outer peripheral side of the boss portion to generate magnetomotive force by power application;
a permanent magnet arranged in a clearance formed between the claw-shaped magnetic pole portions adjacent in the circumferential direction and extending in a direction oblique to the axial direction; and
a tubular member arranged to cover an outer periphery of the claw-shaped magnetic pole portions, wherein
the permanent magnet is held in a state in which an outer end surface in the radial direction is apart from an inner peripheral surface of the tubular member and both end surfaces in the circumferential direction each contact side surfaces of the claw-shaped magnetic pole portions in the circumferential direction, and
the tubular member includes a steel wire spirally wound to form a stack in the axial direction, and is configured such that an inner diameter in a steady state is smaller than an outer diameter of the claw-shaped magnetic pole portions.

4. The rotor of the rotating electrical machine according to claim 3, wherein
the tubular member is configured such that an axial length when the tubular member is attached to the outer periphery of the claw-shaped magnetic pole portions is smaller than a natural length of the tubular member, and has a clearance between at least a pair of turns of the steel wire adjacent in the axial direction.

5. The rotor of the rotating electrical machine according to claim 1, wherein
a carbon amount of a magnetic material forming the tubular member is 0.4 to 1.05%.

6. The rotor of the rotating electrical machine according to claim 1, wherein
the tubular member is configured such that the steels adjacent in the axial direction are coupled and fixed on an inner peripheral side.

7. The rotor of the rotating electrical machine according to claim 1, wherein
the tubular member is configured such that the steels adjacent in the axial direction are coupled and fixed on an outer peripheral side.
